(19) United States
(12) Patent Application Publication
(10) Pub. No.: US 2018/0125045 A1
(43) Pub. Date: May 10, 2018

(54) BUZZ BAIT TYPE LURE

(71) Applicant: OFFICE EUCALYPTUS CO., LTD., Sunto-gun (JP)

(72) Inventor: Yumiko ISHIKAWA, Sunto-gun (JP)

(21) Appl. No.: 15/696,555

(22) Filed: Sep. 6, 2017

(30) Foreign Application Priority Data
Nov. 7, 2016 (JP) 2016-216889

(51) Int. Cl. A01K 85/01; A01K 85/12

(52) U.S. Cl. CPC A01K 85/01; A01K 85/12

(57) ABSTRACT

A buzz bait lure includes a wire, and a blade disposed to rotate around the wire. The blade includes a propeller portion at one side of the blade; a front support portion; and a rear support portion positioned at a side closer to the propeller portion than the front support portion and having a third hole. The front or rear support portion includes a rising portion rising from a flat surface of the blade and having a first hole, and a folding portion having a second hole and folded from the rising portion to face the flat surface of the blade. The blade is supported on the wire at the front support portion and the rear support portion, and the wire is inserted into at least the first hole, the second hole, and the third hole.

### BACKGROUND OF THE INVENTION

### Technical Field

The present invention relates to a buzz bait type lure, and more particularly, to a buzz bait type lure capable of enhancing a fish luring effect.

### Related Art

There is a buzz bait type lure including a blade that reflects light or generates vibration waves, sounds, or bubbles while generating a rotational motion near a water surface (see JP 2000-69882A).

Here, the blade is supported on a wire via two points, a front support portion (front bearing) and a rear support portion (rear bearing).

### Problems to be Solved by the Invention

However, in the buzz bait type lure, since the blade is supported at one point of the front support portion (front bearing) and one point of the rear support portion (rear bearing), respectively, there is a problem in that the blade, which rotates unstably, is not stabilized; the time required to throw in a lure and raise the lure by the rotation of the blade is long; the effect of the buzz bait type lure cannot be exerted at a target place; the fish luring effect is insufficient; the blade is likely to brake from holes of the front support portion (front bearing) or the rear support portion (rear bearing) due to abrasion caused by the rotation of the blade; and a part of the blade deviates from the wire, or the like.

An object of the present invention is to provide a buzz bait type lure capable of enhancing a fish luring effect.

### Means to Solve the Problems

A buzz bait type lure as described in a first aspect is a buzz bait type lure in which a blade rotates around a wire, wherein the blade has a propeller portion, a front support portion, and a rear support portion, the rear support portion is positioned at a side closer to the propeller portion than the front support portion, the front support portion has a front rising portion rising from a flat surface of the blade and a front folding portion folded from the front rising portion and facing the flat surface of the blade, the front rising portion is provided with a first hole, the front folding portion is provided with a second hole, the rear support portion is provided with at least a first′ hole, the wire is inserted into at least the first hole, the second hole, and the first′ hole, and the blade is supported on the wire via the front support portion and the rear support portion.

A buzz bait type lure as described in a second aspect is a buzz bait type lure in which a blade rotates around a wire, wherein the blade has a propeller portion, a front support portion, and a rear support portion, the rear support portion is positioned at a side closer to the propeller portion than the front support portion, the rear support portion has a rear rising portion rising from a flat surface of the blade and a rear folding portion folded from the rear rising portion and facing the flat surface of the blade, the front rising portion is provided with at least a first hole, the rear rising portion is provided with a first′ hole, the rear folding portion is provided with a second′ hole, the wire is inserted into at least the first hole, the first′ hole, and the second′ hole, and the blade is supported on the wire via the front support portion and the rear support portion.

According to the buzz bait type lure as described in a third aspect, in the buzz bait type lure of the first aspect, the front support portion and the rear support portion are positioned at a side different from the flat surface of the blade, a through hole is provided substantially at a center of the blade, the wire is inserted into at least the first hole, the second hole, the through hole, and the first′ hole, and the blade is supported on the wire via the front support portion and the rear support portion.

According to the buzz bait type lure as described in a fourth aspect, in the buzz bait type lure of the second aspect, the front support portion and the rear support portion are positioned at a side different from the flat surface of the blade, a through hole is provided substantially at a center of the blade, the wire is inserted into at least the first hole, the through hole, the first′ hole, and the second′ hole, and the blade is supported on the wire via the front support portion and the rear support portion.

According to the buzz bait type lure as described in a fifth aspect, in the buzz bait type lure of any one of the first to fourth aspects, a tip of the front folding portion is spaced apart from the flat surface of the blade, or a tip of the rear folding portion is spaced apart from the flat surface of the blade.

According to the buzz bait type lure as described in a sixth aspect, in the buzz bait type lure of any one of the first to fourth aspects, a tip of the front folding portion is in contact with the flat surface of the blade or a tip of the rear folding portion is in contact with the flat surface of the blade.

According to the buzz bait type lure as described in the first aspect, the wire is inserted into at least the first hole, the second hole, and the first′ hole, and the blade is supported on the wire via the front support portion and the rear support portion. In other words, since the blade is supported at the two places of the first hole and the second hole at the front support portion, as compared with the conventional blade supported at one place, the effects of smoothly rotating the blade to stably output the sounds, shortening the time required to throw in the lure and raise the lure by the rotation of the blade, more exerting the effect of the vibration waves, sounds, or bubbles of the buzz bait type lure at the target place, enhancing the fish luring effect, and preventing the blade from being broken from the hole due to the abrasion, or the like can be obtained.

In addition, according to the buzz bait type lure as described in the second aspect, the wire is inserted into at least the first hole, the first′ hole and the second′ hole, and the blade is supported on the wire via the front support portion and the rear support portion. In other words, since the blade is supported at the two places of the first′ hole and the second′ hole at the rear support portion, as compared with the conventional blade supported at one place, the effects of smoothly rotating the blade to output the sounds, shortening the time required to throw in the lure and raise the lure by the rotation of the blade, more exerting the effect of the vibration waves, sounds, or bubbles of the buzz bait type lure at the target place, enhancing the fish luring effect, and preventing the blade from being broken from the hole due to the abrasion, or the like can be obtained.

In addition, in addition to the effects of the invention as described in the first aspect described above, according to the buzz bait type lure as described in the third aspect, the front support portion and the rear support portion are positioned on the side different from the flat surface of the blade, the through hole is provided approximately at the center of the blade, the wire is inserted into at least the first hole, the second hole, the through hole, and the first′ hole, and the blade is supported on the wire via the front support portion and the rear support portion. In other words, since the wire penetrates through the hole of the front support portion, the through hole, and the hole of the rear support portion, the blade rotates stably and the rising is made quickly.

In addition, in addition to the effects of the invention as described in the second aspect described above, according to the buzz bait type lure as described in the fourth aspect, the front support portion and the rear support portion are positioned on the side different from the flat surface of the blade, the through hole is provided approximately at the center of the blade, the wire is inserted into at least the first hole, the through hole, and the first′ hole, and the second′ hole, and the blade is supported on the wire via the front support portion and the rear support portion. In other words, since the wire penetrates through the hole of the front support portion, the through hole, and the hole of the rear support portion, the blade rotates stably and the rising is made quickly.

In addition, according to the buzz bait type lure as described in the fifth aspect, the tip of the front folding portion is spaced apart from the flat surface of the blade or the tip of the rear folding portion is spaced apart from the flat surface of the blade. In other words, since the tip of the folding portion is not in contact with the flat surface of the blade, the vibration waves and the sounds are generated by the vibration of the folding portion and the more excellent fish luring effect can be obtained.

In addition, according to the buzz bait type lure as described in the sixth aspect, the tip of the front folding portion is in contact with the flat surface of the blade or the tip of the rear folding portion is in contact with the flat surface of the blade. In other words, since the tip of the folding portion is in contact with the flat surface of the blade, the folding portion can support the wire more stably.

### BRIEF DESCRIPTION OF THE DRAWINGS

FIG. 1 is a photograph of a buzz bait type lure according to an embodiment of the present invention;

FIG. 2 is a photograph of the buzz bait type lure taken from a direction different from that in FIG. 1;

FIG. 3 is a schematic cross-sectional view showing a use state of the buzz bait type lure of FIG. 1;

FIG. 4 is a schematic cross-sectional view of main portions of the buzz bait type lure of FIG. 1;

FIG. 5 is a schematic cross-sectional view of main portions of a buzz bait type lure according to another embodiment different from the embodiment of FIG. 1;

FIG. 6 is a schematic cross-sectional view of main portions of a buzz bait type lure according to a further embodiment different from the embodiment of FIG. 5;

FIG. 7 is a schematic cross-sectional view of main portions of a buzz bait type lure according to a still further embodiment different from the embodiment of FIG. 6;

FIG. 8 is a schematic cross-sectional view of main portions of a buzz bait type lure according to a still further embodiment different from the embodiment of FIG. 7; and

FIG. 9 is a schematic cross-sectional view of main portions of a buzz bait type lure according to a still further embodiment different from the embodiment of FIG. 8.

### DETAILED DESCRIPTION OF THE INVENTION

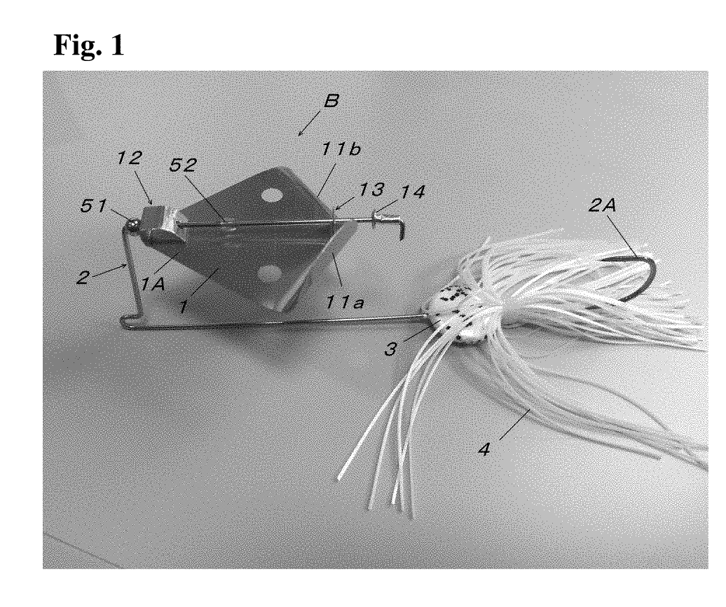

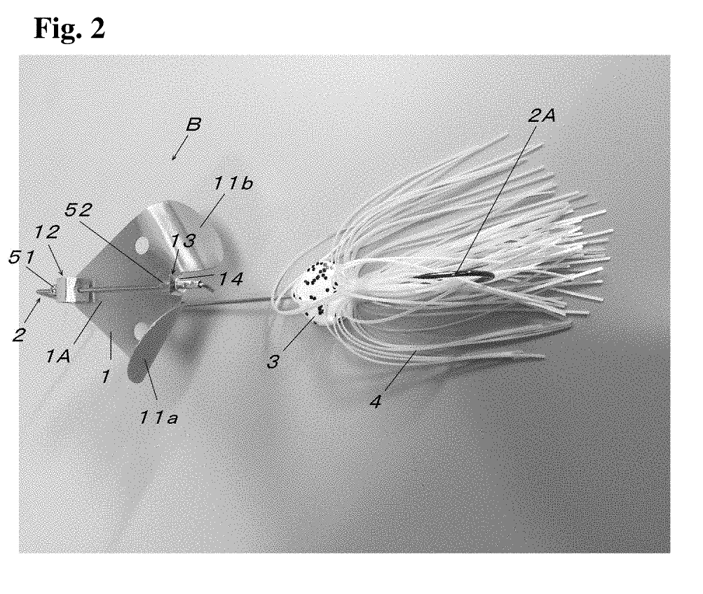

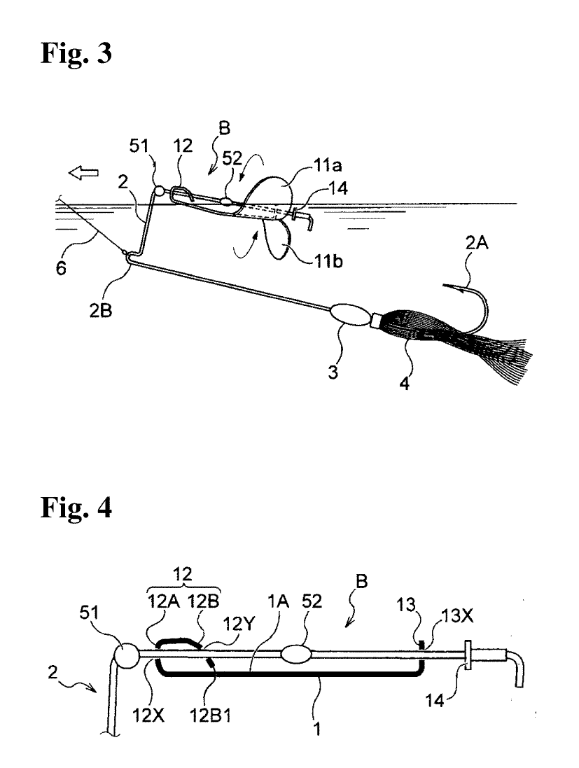

Abuzz bait type lure according to an embodiment of the present invention will be described with reference to drawings (FIGS. 1 to 4).

Reference numeral B shown in FIG. 1 is a buzz bait type lure in which a blade 1 rotates around a wire 2, and the buzz bait type lure B is a lure in which a fishing rod (not shown) is wound while standing and pulled while propeller portions 11a and 11b of the blade 1 being exposed from a water surface.

The blade 1 is formed by machining a plate of a metal (for example, aluminum, aluminum alloy, brass, titanium or the like) and integrally molding the plate with plastic, and the blade 1 includes the propeller portions 11a and 11b, a front support portion (front bearing) 12, and a rear support portion (rear bearing) 13.

It is to be noted that the rear support portion 13 is positioned at aside closer to the propeller portions 11a and 11b than the front support portion 12.

In addition, the front support portion 12 has a front rising portion 12A rising from a flat surface 1A of the blade 1 and a front folding portion 12B folded from the front rising portion 12A and facing the flat surface 1A of the blade 1, and a tip 12B1 of the front folding portion 12B is spaced apart from the flat surface 1A of the blade 1.

The front rising portion 12A is provided with a first hole 12X and the front folding portion 12B is provided with a second hole 12Y. The wire 2 positioned at the front support portion 12 is inserted into the first hole 12X and the second hole 12Y and supports the blade 1. In addition, the rear support portion 13 is provided with at least a first′ hole 13X.

In this manner, the tip 12B1 of the front folding portion 12B is spaced apart from the flat surface 1A of the blade 1. In other words, if the tip 12B1 of the front folding portion 12B is not in contact with the flat surface 1A of the blade 1, unlike the related art, a fish luring effect can be obtained by adding vibrations and sounds generated when the wire 2 is in contact with the second hole 12Y in addition to vibrations and sounds generated when the wire 2 is in contact with the first hole 12X.

The wire 2 is formed by bending a metal wire such as stainless steel and titanium, the wire 2 is inserted into at least the first hole 12X, the second hole 12Y, and the first′ hole 13X, and the blade 1 is supported on the wire 2 via the front support portion 12 and the rear support portion 13.

That is, the blade 1 is rotatably supported on one end side of the wire 2 via the first hole 12X, the second hole 12Y, and the first′ hole 13X, and the other end side of the wire 2 is bent and forms a needle 2A. The one end side and the other end side of the wire 2 are substantially parallel to each other.

Although the one end side and the other end side of the wire 2 are substantially parallel to each other, the present invention is not limited thereto, and the one end side and the other end side of the wire 2 extend toward an open side of the wire 2. For example, it can be similarly applied to even the wire 2 having a shape of <, i.e. bent in a middle of a wire.

Ahead portion 3 is attached to a position closer to the needle 2A than the blade 1 of the wire 2 and a skirt 4 is attached to the head portion 3. The skirt 4 is formed of, for example, rubber (more specifically, silicone rubber or the like).

Reference numerals 51 and 52 shown in FIG. 1 are first and second beads, respectively, and reference numeral 2B is a locking portion for locking a line 6. Further, reference numeral 14 shown in FIG. 1 is a hook member formed of a rivet or the like, and the hook member 14 prevents the blade 1 from separating to stabilize the rotation of the blade 1, and is rubbed with the blade 1 by being in contact with the blade 1 to generate a frictional sound.

Therefore, according to the buzz bait type lure B described above, the wire 2 is inserted through at least the first hole 12X, the second hole 12Y, and the first′ hole 13X, and the blade 1 is supported on the wire 2 via the front support portion 12 and the rear support portion 13. In other words, since the blade 1 is supported at two places of the first hole 12X and the second hole 12Y at the front support portion 12, as compared with the conventional blade supported at one place, the effects of smoothly rotating the blade 1 to stably output the sounds, shortening the time required to throw in the lure and raise the lure by the rotation of the blade 1, more exerting the effect of the vibration waves, sounds, or bubbles of the buzz bait type lure B at the target place, enhancing the fish luring effect, and preventing the blade 1 from being broken from the hole due to the abrasion or the like, can be obtained.

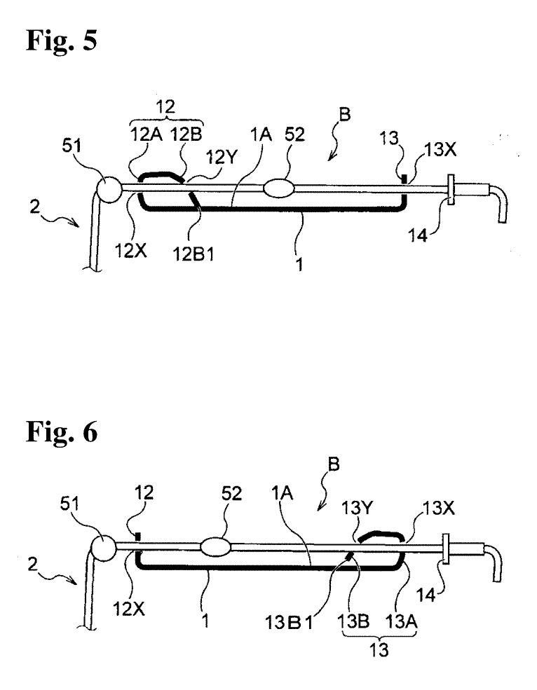

In the embodiments described above with reference to FIGS. 1 to 4, the tip 12B1 of the front folding portion 12B is spaced apart from the flat surface 1A of the blade 1, but the present invention is not limited thereto. For example, as shown in FIG. 5, the tip 12B1 of the front folding portion 12B may contact with the flat surface 1A of the blade 1. If the tip 12B1 of the front folding portion 12B contacts the flat surface 1A, the front folding portion 12B can more stably support the wire 2.

Even in the embodiment described with reference to FIG. 5, like the descriptions with reference to FIGS. 1 to 4, the blade 1 is rotatably supported on one end side of the wire 2 via the first hole 12X, the second hole 12Y, and the first′ hole 13X, although not shown, the other end side of the wire 2 is bent to form a needle, and the one end side and the other end side of the wire 2 are substantially parallel to each other.

In the embodiment described with reference to FIG. 5, the same portions as those in the embodiment described with reference to FIGS. 1 to 4 are denoted by the same reference numerals, and some of the description thereof will be omitted.

In the embodiments described above with reference to FIGS. 1 to 5, the front support portion 12 is provided with the front folding portion 12B, but the present invention is not limited thereto. For example, as shown in FIG. 6, the rear support portion 13 may be provided with a rear folding portion 13B.

That is, like the embodiments described with reference to FIGS. 1 to 5 described above, the blade 1 is supported on the wire 2 via the front support portion 12 and the rear support portion 13, and the rear support portion 13 is positioned at a side closer to the propeller portions 11a and 11b than the front support portion 12.

In addition, the rear support portion 13 has a rear rising portion 13A rising from the flat surface 1A of the blade 1 and a rear folding portion 13B folded from the rear rising portion 13A and facing the flat surface 1A of the blade 1, and a tip 13B1 of the rear folding portion 13B is spaced apart from the flat surface 1A of the blade 1.

It is to be noted that the tip 13B1 of the rear folding portion 13B is spaced apart from the flat surface 1A of the blade 1. In other words, since the tip 13B1 of the rear folding portion 13B is not in contact with the flat surface 1A of the blade 1, vibration waves and sounds are generated by the vibration of the rear folding portion 13B, thereby more enhancing the fish luring effect.

In addition, the rear rising portion 13A is provided with a first′ hole 13X, the rear folding portion 13B is provided with a second′ hole 13Y, the front rising portion 12A is provided with at least the first hole 12X, the wire 2 is inserted into at least the first hole 12X, the first′ hole 13X, and the second′ hole 13Y, and the wire 2 positioned at the rear rising portion 13A is inserted into the first′ hole 13X and the second′ hole 13Y to support the blade 1.

According to the buzz bait type lure B described with reference to FIG. 6, the wire 2 is inserted into at least the first hole 12X, the first′ hole 13X, and the second′ hole 13Y, and the blade 1 is supported on the wire 2 via the front support portion 12 and the rear support portion 13. In other words, since the blade 1 is supported at the two places of the first′ hole 13X and the second′ hole 13Y at the rear support portion 13, as compared with the conventional blade supported at one place, the effects of smoothly rotating the blade 1 to stably output the sounds, shortening the time required to throw in the lure and raise the lure by the rotation of the blade 1, more exerting the effect of the vibration waves, sounds, or bubbles of the buzz bait type lure B at the target place, enhancing the fish luring effect, and preventing the blade 1 from being broken from the hole due to the abrasion, or the like can be obtained.

Even in the embodiment described with reference to FIG. 6, the blade 1 is rotatably supported on one end side of the wire 2 via the first hole 12X, the first′ hole 13X, and the second′ hole 13Y as described with reference to FIGS. 1 to 5 and although not shown, the other end side of the wire 2 is bent to form the needle, and the one end side and the other end side of the wire 2 are substantially parallel to each other.

In the embodiment described with reference to FIG. 6, the same portions as those in the embodiments described with reference to FIGS. 1 to 5 are denoted by the same reference numerals, and some of the a description thereof will be omitted.

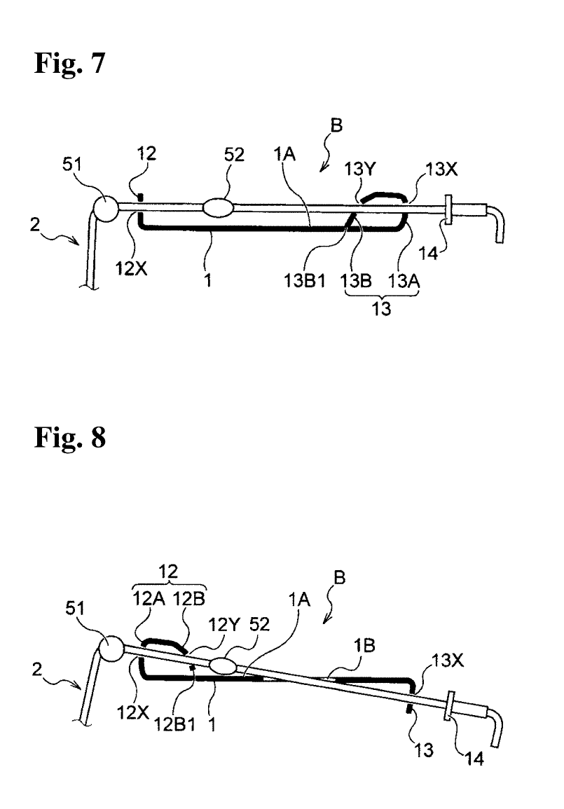

According to the embodiment described with reference to FIG. 6 described above, the tip 13B1 of the rear folding portion 13B is spaced apart from the flat surface 1A of the blade 1, but the present invention is not limited thereto. For example, as shown in FIG. 7, the tip 13B1 of the rear folding portion 13B may contact the flat surface 1A of the blade 1. If the tip 13B1 of the rear folding portion 13B contacts the flat surface 1A, the rear folding portion 13B can more stably support the wire 2.

Even in the embodiment described with reference to FIG. 7, the blade 1 is rotatably supported on one end side of the wire 2 via the first hole 12X, the first′ hole 13X, and the second′ hole 13Y as described with reference to FIGS. 1 to 6 and although not shown, the other end side of the wire 2 is bent to form the needle, and the one end side and the other end side of the wire 2 are substantially parallel to each other.

In the embodiment described with reference to FIG. 7, the same portions as those in the embodiments described with reference to FIGS. 1 to 6 are denoted by the same reference numerals, and some of the description thereof will be omitted.

The front support portion 12 and the rear support portion 13 according to the embodiments described above with reference to FIGS. 1 to 4 are positioned at the same side as the flat surface 1A of the blade 1, but the present invention is not limited thereto. As described with reference to FIG. 8, the front support portion 12 and the rear support portion 13 may be positioned at a side (the side different from the flat surface 1A is a rear side of the flat surface 1A of the blade 1 in FIG. 8) different from the flat surface 1A of the blade 1.

That is, a through hole 1B is provided substantially at the center of the blade 1; the blade 1 is inserted into at least the first hole 12X and the second hole 12Y of the front support portion 12, the through hole 1B and the first′ hole 13X of the rear support portion 13; and the blade 1 is supported on the wire 2 via the front support portion 12 and the rear support portion 13.

Since the wire 2 penetrates through the holes 12X and 12Y of the front support portion 12, the through hole 1B, and the hole 13X of the rear support portion 13, the blade 1 rotates stably and the rising is made quickly.

In addition, even in the embodiment described with reference to FIG. 8, the blade 1 is rotatably supported on one end side of the wire 2 via the first hole 12X, the second hole 12Y, and the first′ hole 13X as described with reference to FIGS. 1 to 7, and although not shown, the other end side of the wire 2 is bent to form the needle and the one end side and the other end side of the wire 2 are substantially parallel to each other.

In the embodiment described with reference to FIG. 8, the same portions as those in the embodiments described with reference to FIGS. 1 to 7 are denoted by the same reference numerals, and some of the description thereof will be omitted.

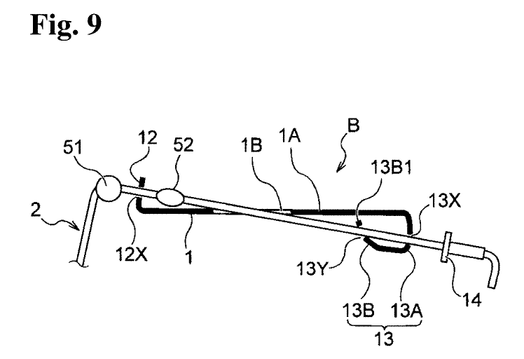

The front support portion 12 and the rear support portion 13 in the embodiments described with reference to FIGS. 1 to 4 described above are positioned at the same side as the flat surface 1A of the blade 1, but the present invention is not limited thereto. As described with reference to FIG. 9, the front support portion 12 and the rear support portion 13 may be positioned at the side different from the flat surface 1A of the blade 1 (the different side is the rear side of the flat surface 1A of the blade 1 in FIG. 9).

That is, the through hole 1B is provided substantially at the center of the blade 1, and the wire 2 is inserted into at least the first hole 12X, the through hole 1B, the first′ hole 13X, and the second′ hole 13Y, and the blade 1 is supported on the wire 2 via the front support portion 12 and the rear support portion 13.

Since the wire 2 penetrates through the hole 12X of the front support portion 12, the through hole 1B, and the holes 13X and 13Y of the rear support portion 13, the blade 1 rotates stably and the rising is made quickly.

In addition, even in the embodiment described with reference to FIG. 9, as described with reference to FIGS. 1 to 8, the blade 1 is rotatably supported on one end side of the wire 2 via the first hole 12X, the first′ hole 13X, and the second′ hole 13Y, and although not shown, the other end side of the wire 2 is bent to form the needle, and the one end side and the other end side of the wire 2 are substantially parallel to each other.

In the embodiment described with reference to FIG. 9, the same portions as those in the embodiments described with reference to FIGS. 1 to 8 are denoted by the same reference numerals, and some of the description thereof will be omitted.

As in the embodiments described with reference to FIGS. 1 to 5 and 8 described above, the blade 1 is provided with the front folding portion 12B, and as in the embodiments described with FIGS. 6, 7, and 9, the blade 1 is provided with the rear folding portion 13B and is separately provided with the folding portion. However, the present invention is not limited thereto, and although not shown, the blade 1 may be provided with two folding portions of the front folding portion 12B and the rear folding portion 13B.

In short, according to the present invention, the blade 1 may be provided with at least any one of the front folding portion 12B and the rear folding portion 13B.

The present invention is described with reference to the specific embodiments of the invention. However, the invention is limited only by the appended claims. The disclosure of Japanese Patent Application No. 2016-216839 filed on Nov. 7, 2016 is incorporated herein as a reference.

What is claimed is:

1. A buzz bait lure comprising:
a wire, and
a blade disposed to rotate around the wire, and including a propeller portion at one side of the blade; a front support portion having a front rising portion rising from a flat surface of the blade and having a first hole, and a front folding portion having a second hole and folded from the front rising portion to face the flat surface of the blade; and a rear support portion positioned at a side closer to the propeller portion than the front support portion and having a third hole,
wherein the blade is supported on the wire at the front support portion and the rear support portion, and the wire is inserted into at least the first hole, the second hole, and the third hole.

2. The buzz bait lure according to claim 1, wherein the front support portion and the rear support portion are positioned at a side different from the flat surface of the blade,
the blade includes a through hole substantially at a center thereof, and
the wire is inserted into at least the first hole, the second hole, the through hole, and the third hole.

3. The buzz bait lure according to claim 1, wherein a tip of the front folding portion is spaced apart from the flat surface of the blade, or
a tip of the rear folding portion is spaced apart from the flat surface of the blade.

4. The buzz bait lure according to claim 1, wherein a tip of the front folding portion contacts the flat surface of the blade, or
a tip of the rear folding portion contacts the flat surface of the blade.

5. A buzz bait lure comprising:
a wire, and
a blade disposed to rotate around the wire, and including a propeller portion at one side of the blade; a front support portion having a front rising portion provided with a first hole; and a rear support portion positioned at a side closer to the propeller portion than the front support portion, and having a rear rising portion provided with a second hole and rising from a flat surface of the blade, and a rear folding portion folded from the rear rising portion to face the flat surface of the blade and having a third hole,
wherein the blade is supported on the wire through the front support portion and the rear support portion, and the wire is inserted into at least the first hole, the second hole, and the third hole.

6. The buzz bait lure according to claim 5, wherein the front support portion and the rear support portion are positioned at a side different from the flat surface of the blade,
the blade includes a through hole substantially at a center thereof, and
the wire is inserted into the first hole, the through hole, the second hole, and the third hole.
